(19) United States
(12) Patent Application Publication
(10) Pub. No.: US 2021/0198295 A1
(43) Pub. Date: Jul. 1, 2021

(54) TRIPHOSPHONATE COMPOSITIONS, SELF-ASSEMBLED TRIPHOSPHONATE MONOLAYERS, PRODUCTS AND APPARATUS MADE FROM SUCH COMPOSITIONS AND MONOLAYERS, AND METHODS OF MAKING AND USING SUCH COMPOSITIONS, MONOLAYERS, PRODUCTS, AND APPARATUS

(71) Applicant: ELECTROLAB, INC., Beorne, TX (US)

(72) Inventors: AJEETA PATIL, SAN ANTONIO, TX (US); SEAN ERIC DREES, BOERNE, TX (US)

(21) Appl. No.: 16/729,605

(22) Filed: Dec. 30, 2019

(51) Int. Cl. C07F 9/40

(52) U.S. Cl. CPC C07F 9/4006

(57) ABSTRACT

Triphosphonate compositions, self-assembled triphosphonate monolayers, products and apparatus made thereof, and methods of making and using such compositions, monolayers, products, and apparatus.

### CROSS-REFERENCE TO RELATED APPLICATIONS

Not Applicable.

### BACKGROUND OF THE INVENTION

### 1. Field of the Invention

The present invention relates to compositions, to products and apparatus made therefrom, and to methods of making and using such compositions, apparatus, and products. In another aspect, the present invention relates to monolayer compositions, to products and apparatus made therefrom, and to methods of making and using such compositions, apparatus, and products. In even another aspect, the present invention relates to self-assembled monolayers (“SAM”s), to products and apparatus made therefrom, and to methods of making and using such compositions, apparatus, and products. In still another aspect, the present invention relates to self-assembling monolayers that have a trifunctional head, to products and apparatus made therefrom, and to methods of making and using such compositions, apparatus, and products.

### 2. Description of Related Art

The recorded history of organic monolayer and multilayer thin films spans approximately 4000 years. Fatty-acid-based monolayers were deposited on water by the ancients for applications ranging from fortune telling in King Hammurabi's time (˜1800 BC, Mesopotamia) to stilling choppy waters for sailors and divers as reported by the Roman philosopher Pliny the Elder in ˜78 AD, and then much later (1774) by the peripatetic American statesman and natural philosopher Benjamin Franklin, to Japanese “floating-ink” art (suminagashi) developed ˜1000 years ago. The modern science of organic monolayers began in the late-1800s/early-1900s with experiments by Lord Rayleigh and the important development by Agnes Pockels, followed two decades later by Irving Langmuir, of the tools and technology to measure the surface tension of liquids, the surface pressure of organic monolayers deposited on water, interfacial properties, molecular conformation of the organic layers, and phase transitions which occur upon compressing the monolayers. In 1935, Katherine Blodgett published a landmark paper showing that multilayers can be synthesized on solid substrates, with controlled thickness and composition, using an apparatus now known as the Langmuir-Blodgett (L-B) trough. A disadvantage of LB films for some applications is that they form weak physisorbed bonds to the substrate.

The history of self-assembly is often started by discussing the early work of Zisman. A Self-Assembled Monolayer (SAM) is a one molecule thick layer of material that bonds to a surface in an ordered way as a result of physical or chemical forces during a deposition process. A SAM comprises assemblies that each consist of a head group (sometimes called “anchor”), tail (sometimes called “linker”), and functional end group (sometimes called “tail”), with common head groups including thiols, silanes, phosphonates, etc. The tail typically comprises a molecular chain with the head group on one end and the functional end group on the other end of the chain. The head is typically selected to be compatible with the surface to which it will attach, and the functional end group is typically selected to provide a desired property (i.e., hydrophobic, oleophobic, a certain reactivity, a certain functionality, etc).

Some milestone's in the self-assembly art include Zisman's 1946 publication that introduced the self-assembly of a long chain alcohol, amine and carboxylic acid on glass and clear metal surfaces, continuing in the 1950s with Murphy's U.S. Pat. No. 2,841,501 disclosing the self-assembly of alkanethiols, and continuing in the 1980s with Nuzzo and Allara's assembly of alkyltricholorsilanes on silicon oxide and the assembly of alkanethiols.

Essentially, a SAM comprises molecular assemblies formed spontaneously on surfaces by adsorption and are organized into more or less large ordered domains. In some cases, molecules that form the monolayer do not interact strongly with the substrate. This is the case for instance of the two-dimensional supramolecular networks of e.g. perylenetetracarboxylic dianhydride (PTCDA) on gold or of e.g. porphyrins on highly oriented pyrolitic graphite (HOPG). In other cases, the molecules possess a head group that has a strong affinity to the substrate and anchors the molecule to it.

SAMs are created by the chemisorption of “head groups” onto a substrate from either the vapor or liquid phase followed by a slow organization of “tail groups”. Initially, at small molecular density on the surface, adsorbate molecules form either a disordered mass of molecules or form an ordered two-dimensional “lying down phase”, and at higher molecular coverage, over a period of minutes to hours, begin to form three-dimensional crystalline or semicrystalline structures on the substrate surface. The “head groups” assemble together on the substrate, while the tail groups assemble far from the substrate. Areas of close-packed molecules nucleate and grow until the surface of the substrate is covered in a single monolayer.

Selecting the type of head group depends on the application of the SAM. Typically, head groups are connected to a molecular chain in which the terminal end can be functionalized (i.e. adding —OH, —NH₂, —COOH, or —SH groups) to vary the wetting and interfacial properties. An appropriate substrate is chosen to react with the head group. Substrates can be planar surfaces, such as silicon and metals, or curved surfaces, such as nanoparticles. Alkanethiols are the most commonly used molecules for SAMs. Alkanethiols are molecules with an alkyl chain, (—CH₂—CH₂-)ₙ chain, as the back bone, a tail group, and a S—H head group. Other types of interesting molecules include aromatic thiols, of interest in molecular electronics, in which the alkyl chain is (partly) replaced by aromatic rings. An example is the dithiol 1,4-benzenedimethanethiol (SHCH₂C₆H₄CH₂SH)). Interest in such dithiols stems from the possibility of linking the two sulfur ends to metallic contacts, which was first used in molecular conduction measurements. Thiols are frequently used on noble metal substrates because of the strong affinity of sulfur for these metals. The sulfur gold interaction is semi-covalent and has a strength of approximately 45 kcal/mol. In addition, gold is an inert and biocompatible material that is easy to acquire. It is also easy to pattern via lithography, a useful feature for applications in nanoelectromechanical systems. Additionally, it can withstand harsh chemical cleaning treatments. Recently other chalcogenide SAMs: selenides and tellurides have attracted attention in a search for different bonding characteristics to substrates affecting the SAM characteristics and which could be of interest in some applications such as molecular electronics. Silanes are generally used on nonmetallic oxide surfaces.

There are a number of patents and publications relating to SAMs, the following of which are merely a sampling.

U.S. Pat. No. 6,146,767 issued Nov. 14, 2000, to Schwartz, discloses self-assembled organic ligand monolayers on the surface of a metal oxide or silicon oxide substrate overlayer, wherein transition metal atoms selected from Group IV, Group V or Group VI of the Periodic Chart are covalently bonded to the surface oxygens of the substrate, and each transition metal atom is further covalently bonded to one or more of the organic ligands of the monolayer, thereby covalently bonding the organic monolayer to the substrate overlayer. Methods of forming the self-assembled organic ligand monolayers of the present invention are also disclosed.

US Patent Publication No. 20050153938A1 published Jul. 14, 2005, by Denizot et al., discloses certain polyphosphonate derivatives for toothpaste compositions.

US Patent Application No. 20070042154 published Feb. 22, 2007, by Mehmet Hancer discloses a protective coating for a substrate includes a diamond-like carbon (DLC) layer overlying the substrate and having gaps where the substrate is not protected by the diamond-like carbon layer, with the protective coating also including a self-assembled monolayer formed in the gaps of the diamond-like carbon layer.

U.S. Pat. No. 7,268,363 issued Sep. 11, 2007, to Lenhard et al., discloses photosensitive organic semiconductor compositions comprising an organic p-type semiconductor pigment with a p-type conducting polymer, wherein the ionization potentials of the organic p-type semiconductor pigment and the p-type conducting polymer are nominally equivalent and a photosensitive organic semiconductor composition comprising an organic n-type semiconductor pigment with an n-type conducting polymer, wherein the electron affinities of the organic semiconductor pigment and the conducting polymer are nominally equivalent. Also disclosed are a p/n heterojunction utilizing the photosensitive organic semiconductor compositions.

US Patent Application Publication No. 20080131709 published Jun. 5, 2008, to Hanson et al., discloses an article comprising: a substrate having a surface and comprising electrodeposited copper foil or copper alloy foil; an adherent layer serving to promote adhesion, comprising at least one organophosphonate or salt thereof covalently bound to the surface; and a functional layer, comprising at least one polymer bound to the adherent layer. The present invention further provides devices comprising a heat source or electronic component and the article described above, wherein the heat source is in thermal contact with the substrate and the electronic component is in electrical contact with the substrate. Also provided is a method of producing the above-described article.

U.S. Pat. No. 7,396,594 issued Jul. 8, 2008, to Schwartz et al., discloses carrier applied coating layers and a process for providing on the surface of a substrate an adherent phosphorous acid-based coating layer, the method comprising contacting said surface with a carrier conveying a composition comprising an acid selected from the group consisting of phosphoric acids, organo-phosphoric acids, phosphonic acids, and mixtures thereof, at a sufficient temperature and for a sufficient time to bond at least a portion of the acid in the composition to the oxide surface.

U.S. Pat. No. 7,471,503 issued Dec. 30, 2008, to Bruner et al., discloses solid electrolytic capacitors that comprise an organophosphorus material positioned between the dielectric layer and the polymeric electrolyte layer. The organophosphorus compound improves the interlayer adhesion between the dielectric and electrolyte layers.

EP 2054165B1, published May 6, 2009, by Portet et al., discloses methods of covering self-assembled metal or inorganic surfaces with gem-bisphosphonic compounds, characterized in that it comprises the following successive steps: a) prior oxidation of the surface of the substrate if it is not already at least partially hydroxylated so as to arrange hydroxyl functions on the surface of the substrate, b) contact of the surface of the substrate with a liquid, gaseous or supercritical composition containing gem-bisphosphonic compounds, and/or their toxicologically acceptable salts, until self-assembly of said gem-bisphosphonic compounds in a layer covering said surface, c) removal of said liquid, gaseous or supercritical composition, d) dehydration of the surface thus covered; the substrate recovered capable of being obtained from this method, uses of this functionalized substrate, gem-bisphosphonic compounds that can use this coating method, and uses of these gem-bisphosphonic compounds.

US Patent Application Publication No. 20090246394 published Oct. 1, 2009, to Hanson et al., discloses a method for applying a hydrophobic coating to a surface of a display screen.

U.S. Pat. No. 7,625,149 issued Dec. 1, 2009, to Hanson et al., discloses a method and applicator for applying hydrophobic compositions to surfaces, wherein the applicator comprises an applicator tip fixed to a housing, and contained within the housing is a flowable hydrophobic composition of a metal silicon complex, and wherein the method includes applying the hydrophobic composition to a surface by rubbing the applicator tip across the surface.

U.S. Pat. No. 7,691,478 issued Apr. 6, 2010, to Avaltroni et al., discloses structures comprising substrates comprised of an organic material capable of accepting a proton from an organophosphorous compound and a film of the organophosphorous compound bonded to the substrate, which structures are useful in a variety of applications such as visual display devices.

U.S. Pat. No. 7,740,940 issued Jun. 22, 2010, to Hanson, discloses a coated article comprising a substrate having a plastic surface and adhered thereto an organometallic film in which the metal has f electron orbitals or is niobium, and also discloses methods for applying organometallic films to substrates and the organometallic films themselves.

U.S. Pat. No. 7,879,437 issued Feb. 1, 2011 to Hanson, discloses a non-particulate substrate having adhered thereto a composition comprising the reaction product of a transition metal compound such as niobium and a transition metal having electrons in the f orbital, and a silicon-containing material such as an organosilane or an organo(poly)siloxane, and discloses that reaction of the silicon-containing material with the transition metal compound results in a better adhering coating to the substrate than a comparable coating prepared from the silicon-containing material itself. U.S. Pat. No. 7,879,456 issued Feb. 1, 2011, to Schwartz et al., discloses methods for bonding adherent phosphorous-containing coating layers to oxide surfaces on substrates wherein the substrates with oxide surfaces are selected from: (a) oxidized iron, titanium, silicon, tin and vanadium; (b) indium tin oxide; and (c) substrates with oxide layers deposited thereon, wherein the substrates on which oxide layers are deposited are selected from ceramics, semiconductors, metals, plastics and glass, and the method contacts the oxide surface with a carrier conveying an organo-phosphonic acid composition and heats the oxide surface and carrier at a sufficient temperature while maintaining contact for a sufficient time to bond a layer of the organophosphonic acid to the oxide surface. Coated articles prepared by the inventive method are also disclosed.

U.S. Pat. No. 7,901,777 issued Mar. 8, 2011, and U.S. Pat. No. 8,337,985 issued Dec. 25, 2012, both to Hanson, disclose a coated article comprising a substrate having a plastic surface and adhered thereto an organometallic film in which the metal has f electron orbitals or is niobium. Also disclosed are methods for applying organometallic films to substrates and the organometallic films themselves.

U.S. Pat. No. 7,989,069 issued Aug. 2, 2011, to Bruner et al., discloses an organometallic coating deposited from a metal alkoxide composition under conditions sufficient to form a polymeric metal oxide coating with unreacted alkoxide and hydroxyl groups. Also disclosed are substrates coated with the organometallic coating and a method for applying the organometallic coating to a substrate.

U.S. Pat. No. 8,025,974 issued Sep. 27, 2011, and U.S. Pat. No. 8,236,426 issued Aug. 7, 2012, both to Hanson et al., disclose inorganic substrates with a hydrophobic surface layer of a fluorinated material, wherein the fluorinated material can be directly adhered to the inorganic substrate or can be indirectly adhered to the inorganic substrate through an intermediate organometallic coating.

US Patent Application Publication No. 20110252884 published Oct. 20, 2011 to Hanscombe et al., discloses a vibrating cylinder transducer for measuring the pressure or density of a fluid medium comprising: a cylindrical vibrator, in use having at least one surface coupled to a fluid medium to be measured; a drive means for vibrating the cylindrical vibrator; a sensor for detecting the resonant frequency of the cylindrical vibrator; and an output coupled to the sensor, the output configured to provide an output signal indicative of the pressure and/or the density of the fluid medium; wherein the surface coupled to the fluid medium is coated in a corrosion resistant polymer layer. Preferably the corrosion resistant polymer layer is formed from parylene, with self-assembled monolayer phosphonate coatings also mentioned.

U.S. Pat. No. 8,048,487 issued Nov. 1, 2011, and U.S. Pat. No. 8,524,367 issued Sep. 3, 2013, both to Hanson, disclose organometallic coatings or films, substrates coated with such films and methods for applying the films to the substrates. The organometallic film or coating is derived from a transition metal compound containing both halide ligands and alkoxide ligands. Coated articles comprising polymer substrates and adhered to the substrate surface an organometallic film in which the metal comprises halide and alkoxide ligands are also disclosed.

U.S. Pat. No. 8,053,081 issued Nov. 8, 2011, to Petcavich et al., discloses a cutting tool having a cutting edge with a layer of an organophosphorus compound.

U.S. Pat. No. 8,067,103 issued Nov. 29, 2011, to Hanson, discloses optical articles such as ophthalmic lenses containing a thin hydrophobic surface layer of a fluorinated material adsorbed thereon.

US Patent Application Publication No. 20120003481 published Jan. 5, 2012, by Hanson, discloses organometallic coatings or films, substrates coated with such films and methods for applying the films to the substrates. The organometallic film or coating is derived from a transition metal compound containing both halide ligands and alkoxide ligands. Coated articles comprising polymer substrates and adhered to the substrate surface an organometallic film in which the metal comprises halide and alkoxide ligands are also disclosed.

US Patent Application Publication No. 20120104362, published May 3, 2012, by Hanson et al., discloses a method for altering an electronic property of a structure comprising an oxide surface or an oxide surface in electronic communication with the structure, the method comprising providing a covalently-bound film comprising at least one organic acid residue on a portion of the oxide surface so that at least one of the following properties of the structure is modified: (a) the charge carrier injection barrier properties; (b) the charge conductivity properties; (c) the charge transport properties; (d) the work function properties; (e) the sub-threshold slope; and (f) the threshold voltage.

U.S. Pat. No. 8,178,004 issued May 15, 2012, to Hanson, discloses a composition and method for forming a hydrophobic coating on a metallic substrate. The composition comprises: (a) a perfluorinated acid, (b) a surfactant, (c) an organic solvent, and (d) water. The composition is applied to the metal surface, the organic solvent and water permitted to evaporate and coalesce to form a substantially continuous film that preferably is in the form of a self-assembled monolayer covalently bonded to the surface of the substrate.

U.S. Pat. No. 8,432,036 issued Apr. 30, 2013, to Hanson et al., discloses a lead frame and an electronic package having improved adhesion between the lead frame and an encapsulating plastic material. The lead frame can be pre plated having an outer layer comprising a precious metal such as palladium or gold to which is adhered a self-assembled monolayer (SAM), such as a SAM derived from an organophosphorus acid. The organophosphorus acid preferably is a mixture in which the organo groups are fluoro substituted hydrocarbons and hydrocarbons containing ethylenically unsaturated groups.

U.S. Pat. No. 8,445,423 issued May 21, 2013, to Bruner et al., discloses wipes treated with organometallic compounds used in combination with organic acids in kit form, particularly organophosphorus acid. The kits can be used to treat various surfaces to alter the physical properties of the surfaces.

U.S. Pat. No. 8,558,117 issued Oct. 15, 2013, to Hanson, discloses an electroconductive ink made with metallic nanoparticles. The ink contains an organophosphorus acid that increases adhesion between the deposited metallic layer and the substrate to which the metallic layer is applied.

U.S. Pat. No. 8,658,258 issued Feb. 25, 2014, to Hanson, discloses an improved method for forming a self-assembled monolayer on a substrate, in which the method comprises plasma treatment of the substrate prior to formation of the self-assembled monolayer.

US Patent Application Publication No. 20140272149, published Sep. 18, 2014, by Hanson, discloses a process for forming a polymer film on a substrate through an intermediate organometallic layer. A self-assembled monolayer (SAM) containing an initiator for living polymerization such as controlled radical polymerization is formed on the organometallic layer followed by living polymerization such as controlled radical polymerization of a polymerizable monomer component.

US Patent Application Publication No. 20140272150 published Sep. 18, 2014, by Hanson, discloses a process for forming a fluorocarbon polymer film on a substrate. A self-assembled monolayer (SAM) containing an initiator for living polymerization such as controlled radical polymerization is formed on the surface of the substrate followed by living polymerization such as controlled radical polymerization of a polymerizable fluorocarbon monomer component.

US Patent Application Publication No. 20140272428 published Sep. 18, 2014, by Hanson, discloses a betaine-containing polymer film that can be formed on a substrate surface using living polymerization such as controlled radical polymerization.

US Patent Application Publication No. 20150083397 published Mar. 26, 2015, by Monroe et al., discloses that fouling caused by contaminants onto a metallic tubular, flow conduit or vessel in an underground reservoir or extending from or to an underground reservoir may be inhibited by applying onto the surface of the metallic tubular, flow conduit or vessel a treatment agent comprising a hydrophobic tail and an anchor. The anchor attaches the treatment agent onto the surface of the metallic tubular, flow conduit or vessel.

US Patent Application Publication No. 20150252656 published Sep. 10, 2015, by Hanson, discloses a method for recovering hydrocarbon material from a subterranean formation includes introducing a treatment fluid into the subterranean formation. One treatment fluid includes at least one organometallic material having a metal or metalloid from Group III of the Periodic Table or a transition metal. An optional second fluid having an organophosphorous material can also be introduced. Another treatment fluid includes the reaction product of a transition metal compound and a silicon-containing material.

US Patent Publication No. 20250299561 published Oct. 22, 2015, by Monroe et al., discloses a well treatment fluid that contains a surface modifying treatment agent having an anchor and a hydrophobic tail. The surface modifying treatment agent is an organophosphorus acid derivative. After the well treatment fluid is pumped into a well penetrating the subterranean formation, the anchor binds to the surface of the formation. The subterranean formation is a siliceous formation or a metal oxide-containing subterranean formation. The anchor bonds to a Si atom when the formation is a siliceous formation and to the metal of the metal oxide when the formation is a metal oxide-containing formation. After being bound to the surface of the formation, frictional drag within the well is reduced. This allows for faster recovery of formation fluids. The bonding of the surface modifying treatment agent onto the formation may further be enhanced by first pre-treating the formation with an aqueous fluid. By increasing the number of sites for the surface modifying treatment agent to bind onto the surface of the subterranean formation, productivity is improved.

U.S. Pat. No. 9,748,506, issued Aug. 29, 2017, to Kelliher et al., discloses self-assembled monolayer overlying a carbon nanotube substrate, including a semiconductor device that includes a carbon nanotube substrate, a self-assembled monolayer, and a gate oxide. The self-assembled monolayer overlies the carbon nanotube substrate and is comprised of molecules each including a tail group, a carbon backbone, and a head group. The gate oxide overlies the self-assembled monolayer, wherein the self-assembled monolayer forms an interface between the carbon nanotube substrate and the gate oxide.

US Patent Application Publication No. 20180076027 published Mar. 15, 2018, by Kandabara Tapily, discloses selective metal oxide deposition using a self-assembled monolayer surface pretreatment, in which according to one embodiment, the method includes providing a substrate containing a dielectric layer and a metal layer, exposing the substrate to a reactant gas containing a molecule that forms self-assembled monolayers (SAMs) on the substrate, and thereafter, selectively depositing a metal oxide film on a surface of the dielectric layer relative to a surface of the metal layer by exposing the substrate to a deposition gas.

US Patent Application Publication No. 20190048204 published Feb. 14, 2019, by Stephane et al., discloses compositions comprising bisphosphonic compounds dissolved in a fluorinated solvent, and use thereof for covering the surface of a part, relates to a liquid composition characterized in that it contains at least one bisphosphonic compound bearing at least one partially fluorinated, perfluorinated (PF) or perfluorpolyether (PFPE) group, and in that the bisphosphonic compound is dissolved in at least one non-flammable fluorinated solvent.

However, in spite of the many advancements in the prior art, there remains a need for improved self-assembled monolayers, products and apparatus made thereof, and methods of making and using such monolayers, products, and apparatus.

These and other needs will become apparent to those of skill in the art upon review of this application.

### BRIEF SUMMARY OF THE INVENTION

According to some non-limiting embodiments of the present invention, there are provided improved self-assembled monolayers, products and apparatus made thereof, and methods of making and using such monolayers, products, and apparatus.

According to other non-limiting embodiments of the present invention, there are provided compositions comprising a head (also termed as ‘anchor’ in some cases) having at least 3 phosphonate groups, a functional end group (also termed as ‘tail’ in some cases), a linker having a first end and a second end, with the head positioned at the first end of the linker, and the functional end group appended to the second end of the linker.

According to even other non-limiting embodiments of the present invention, there are provided products having a surface, wherein at least a portion of the surface comprises a composition comprising a head having at least 3 phosphonate groups, a functional end group, a linker having a first end and a second end, with the head positioned at the first end of the linker, and the functional end group appended to the second end of the linker.

According to still another non-limiting embodiments of the present invention, there are provided machines comprising a surface, wherein at least a portion of the surface comprises a composition comprising a head having at least 3 phosphonate groups, a functional end group, a linker having a first end and a second end, with the head positioned at the first end of the linker, and the functional end group appended to the second end of the linker.

According to yet another non-limiting embodiment of the present invention, there are provided methods of treating a surface, comprising contacting the surface with a treating composition comprising a head having at least 3 phosphonate groups, a functional end group, a linker having a first end and a second end, with the head positioned at the first end of the linker, and the functional end group appended to the second end of the linker.

These and other embodiments of the present invention will become apparent to those of skill in the art upon review of this application.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a schematic showing one non-limiting embodiment of a reaction scheme suitable for use in the present invention.

### DETAILED DESCRIPTION OF THE INVENTION

It is to be understood that the following disclosure provides many different non-limiting embodiments, or examples, for implementing different features of various non-limiting embodiments. Specific examples of compositions are described below to simplify the disclosure and are not intended to limit the scope of the claims. These are, of course, merely examples and are not intended to be limiting of the scope of the claims. The section headings used herein are for organizational purposes and are not to be construed as limiting the subject matter described.

The present invention provides for triphosphonate compositions, self-assembled triphosphonate monolayers, products and apparatus made thereof, and methods of making and using such compositions, monolayers, products, and apparatus.

The compositions of the present invention comprise a head having at least 3 phosphonate groups (usually a triphosphonate), a functional end group, a linker, with the head and end group affixed to and positioned at opposite ends of the linker.

Certain non-limiting embodiments of the triphosphonate compositions of the present invention may be represented by the following Formula I, Formula II, Formula III and/or mixtures thereof. Of course, the compositions of the present invention are not meant to be limited by the following Formulas I, II and III, but rather compositions of the present invention include all SAM precursors that comprise a head having at least 3 phosphonate groups, any functional end group, and any linker joining the head and end groups.

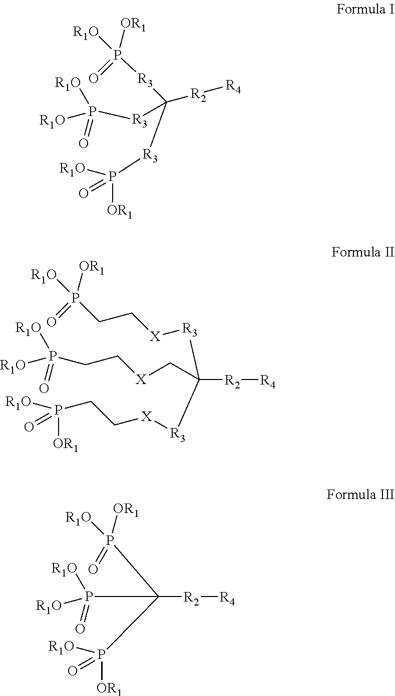

For each Formula I, II and III:
Each R₁ can independently be selected from a group consisting of H, Li, Na, K, or substituted or unsubstituted, linear or branched, saturated or unsaturated, alkyl group having from 1 to 20 carbon atoms (it should be understood that any two R₁'s may be the same or different);
R₂ can be selected from a group consisting of a single chemical bond, or —O—, or —S—, or —NH—; R₂ is preferably a single chemical bond;
Each R₃ can independently represent an alkyl group which may be linear or branched, substituted or unsubstituted, saturated or unsaturated and can have up to 50 carbon atoms. Preferably R₃ can be an —(CH₂)ₘ—, where for each R₃, m is independently selected to be an integer from 1 to 50 (it should be understood that any two R₃'s may be the same or different); and/or,
R₄ can be an alkyl group which may be linear or branched, substituted or unsubstituted, saturated or unsaturated and can have up to 50 carbon atoms.
OR
R₄ can also be is selected from a group which may consist of —(CH₂)ₙ—Y₁—Z or —(CH₂)ₙ—Y₁—(CH₂)ₚ—Y₂—Z, wherein n and p, are independently integers between 1 and 50 and may be the same or different, and wherein Y₁ and Y₂ are independently selected from a group consisting of a single chemical bond, or —O—, —S—, —NH—, —OCO—, —SCO—, —HNCO—, —HNCO—CF(CF₃)— group;
wherein Z can represent H or R_{f}, or —(OCF₂CF₂)ₙ—OR_{f}, or —(OCF₂CF(CF₃))ₙ—OR_{f}, or —(OCF(CF₃)CF₂)ₙ—OR_{f}, wherein R_{f} could be a perfluorinated alkyl, that may be linear or branched, saturated or unsaturated, substituted or unsubstituted, having from 1 to 50 carbon atoms.
Each X can independently be selected from a group consisting of a single bond, or —O—, or —S— (it should be understood that any two X's may be the same or different).

In other non-limiting embodiments of the present invention, R₁ comprises a linear alkyl. In even other non-limiting embodiments of the present invention, R₁ comprises an unsubstituted linear alkyl. In even other non-limiting embodiments of the present invention, R₁ comprises a substituted linear alkyl.

In other non-limiting embodiments of the present invention, R₁ comprises a branched alkyl. In even other non-limiting embodiments of the present invention, R₁ comprises an unsubstituted branched alkyl. In even other non-limiting embodiments of the present invention, R₁ comprises a substituted branched alkyl.

It should be understood that the various R₁'s may be the same or different type of alkyls, and may be selected from the group of alkyl types consisting of branched alkyls, unsubstituted branched alkyls, substituted branched alkyls, linear alkyls, unsubstituted linear alkyls, and substituted linear alkyls, any of which may be saturated or unsaturated.

In other non-limiting embodiments of the present invention, R₁ may comprise an alkyl group having more than 20 carbon atoms.

In even other non-limiting embodiments of the present invention, R₁ may comprise an alkyl group having a number of carbon atoms equal to any one of the following numbers, or having a number of carbon atoms in the range from/to or between any two of the following numbers: 1, 2, 3, 4, 5, 6, 7, 8, 9, 10, 11, 12, 13, 14, 15, 16, 17, 18, 19, and 20.

In even other non-limiting embodiments of the present invention, R₁ may comprise an alkyl group having a number of carbon atoms equal to any one of the following numbers, or having a number of carbon atoms in the range from/to or between any two of the following numbers: 1, 2, 3, 4, 5, 6, 7, 8, 9, and 10.

In even other non-limiting embodiments of the present invention, R₁ may comprise an alkyl group having a number of carbon atoms equal to any one of the following numbers, or having a number of carbon atoms in the range from/to or between any two of the following numbers: 1, 2, 3, 4, and 5.

In other non-limiting embodiments of the present invention, R₄ may comprise more than 50 carbon atoms, and n and/or p may be an integer greater than 50.

In even other non-limiting embodiments of the present invention, with respect to R₄, n and p, may be the same or different, and each may be equal to any one of the following integers, or may be an integer in the range from/to or between any two of the following integers: 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30.

In even other non-limiting embodiments of the present invention, with respect to R₄, n and p, may be the same or different, and each may be equal to any one of the following integers, or may be an integer in the range from/to or between any two of the following integers: 1, 2, 3, 4, 5, 6, 7, 8, 9, 10, 11, 12, 13, 14, 15, 16, 17, 18, 19, and 20.

In even other non-limiting embodiments of the present invention, with respect to R₄, n and p, may be the same or different, and each may be equal to any one of the following integers, or may be an integer in the range from/to or between any two of the following integers: 1, 2, 3, 4, 5, 6, 7, 8, 9, and 10.

The compositions of the present invention are generally made by appending a trisphosphonic acid structure to one end of a linker chain as the “head” group (also termed an ‘anchor’ in some cases), and appending a desired functional group to the other end of the linker chain (as the end group, also termed as ‘tail’ in some cases).

Non-limiting examples of suitable acid structures having at least 3 phosphonic groups that are useful in the present invention include:

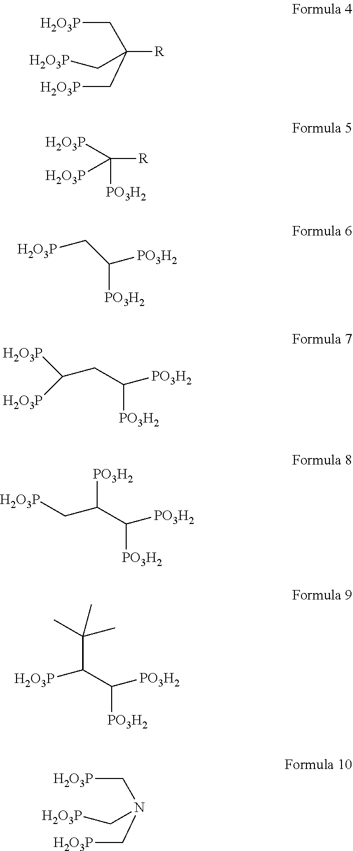

Various functional end groups are well known in the SAM art, and any functional group suitable for the end application may be utilized in the present invention. Any particular SAM molecule may comprise one or more functional groups, and a collection of SAM molecules may comprise one or more functional groups distributed among one or more of the SAM molecules of the collection. Non-limiting examples of suitable end groups include those disclosed by Ulrike Kraft et al. in the Journal of Materials Chemistry, 2010, 20, 6414-6418, and by Michael Salinas, Interface Engineering with Self-assembled Monolayers for Organic Electronics, FAU University Press (2014), both of which are herein incorporated by reference for all that they teach and suggest. In various non-limiting embodiments of the present invention, end groups may be hydrophilic, hydrophobic, oleophilic, oleophobic, or any combinations of two or more of the foregoing.

The present invention provides for the modification of any substrates to which the head group may attach. Non-limiting examples of suitable substrates include those whose free surface comprises titanium, vanadium, chromium, manganese, iron, cobalt, nickel, copper, zinc, aluminum, tungsten, zirconium, steel, stainless steel, or alloys thereof or oxides, such as sapphire or ruby, silicon or germanium, optionally doped, or their oxides, or quartz, mica, glass, limestone, or subterranean formation.

According to methods of the present invention, the substrate surface is contacted with a covering liquid composition containing triphosphonate compounds to allow for the self-assembly of said triphosphonate compounds in a monolayer covering said surface.

It should be understood, that the triphosphonate composition can be liquid, gaseous or supercritical.

In those non-limiting embodiments in which the triphosphonate composition is liquid, the composition containing triphosphonate compounds may be an aqueous or organic composition. In some non-limiting embodiments, it should be understood, that the solvent of the liquid composition is selected so as to allow the solubilization of these triphosphonate compounds. In some non-limiting embodiments, the organic solvent may be selected from alcohols, aldehydes, ketones, ethers, alkanes, and mixtures thereof. Non-limiting examples of alcohols suitable for use as solvents include alcohols having from 1 to 6 carbon atoms, non-limiting examples of which include isopropanol, ethanol, and methanol. Non-limiting examples of the ketones suitable for use as solvents includes acetone. Non-limiting examples of ethers suitable for use as solvents includes diethyl ether or tetrahydrofuran. Non-limiting examples of alkanes includes alkanes having from 1 to 8 carbon atoms.

In some non-limiting embodiments, the triphosphonate composition may be gaseous, and applied to the surface to be treated in a vapor state.

In some non-limiting embodiments, the triphosphonate composition may be a “supercritical composition” meaning that the composition that is in a supercritical fluid state. As a non-limiting example, the solvent of such a supercritical composition may be supercritical carbon dioxide.

The composition of the present invention is advantageously utilized in the form of a solution, suspension, emulsion, of a supercritical fluid, an aerosol or a foam.

In some non-limiting embodiments, the method of contacting of the triphosphonate liquid composition to overlap with the substrate surface may be carried out by coating, dipping, flushing, spin coating, wiping, spraying, and/or contact applying, to name only a few non-limiting examples.

In some non-limiting embodiments, the contacting of the covering liquid composition with the substrate surface may be performed by dipping the substrate in an aqueous solution containing between 0.001 and 5% of triphosphonate composition, for a time comprised between 0.1 seconds and 3 hours at room temperature with or without stirring.

In those non-limiting embodiments in which the composition is gaseous or supercritical state, the contacting with the surface of the substrate may be carried out using a reactor whose pressure and temperature are controllable and which allows the injection of a gas.

After the step of contacting the substrate with the composition, the procedure is the removal of the composition, to remove the surface of the substrate the solvent and all the trisphosphonic solute that is not attached to the substrate during contacting. As non-limiting examples, the removal of the excess composition may be accomplished by rinsing, or mechanically by draining, centrifugation or evaporation.

The substrate may be further rinsed, in particular by immersion in a suitable solvent, in order to ensure complete removal of excess composition.

Once the deposition of the molecular layer of triphosphonate compounds is formed, the method of the present invention may include drying of the modified surface. Without being bound to this theory, it is assumed that drying of the triphosphonate layer formed on the substrate allows the formation of a bond, in some cases a covalent type bond between the triphosphonate molecules and free hydroxyl functions of the surface of the substrate. In practice, the drying of the substrate surface may be carried out by heating thereof to a temperature between 20° C. and 150° C., preferably at 20−50° C. for a time between 10 secs and 72 hours, preferably for about 10 secs to 1 hr. All these different successive steps may be repeated several times cyclically.

In the present context, “solvent” means a substance, preferably liquid, which has the property of dissolving or diluting other substances without chemically modifying them and without itself being modified.

In the present context, “fluorinated solvent” means a solvent or mixture of solvents at least one component of which is partially fluorinated or perfluorinated. In the present context, “non-flammable” or “non-inflammable” means a chemical that does not have a flash point or has a flash point above 60° C.

Preferably, the solvents of the invention include HFCs (hydrofluorocarbons), HFEs (hydrofluoroethers), HFOs (hydrofluoroolefins), PFPEs (perfluoropolyethers), aqueous or alcoholic solvents, aldehydes, ketones, ethers, alkanes, naphthas or a mixture thereof (cf. EP 2054165, WO 2013/167624, WO 2012/085130, all of which are herein incorporated by reference).

In general, the SAMs of the present invention find utility in a wide range of applications, including those applications in which SAMs are traditionally utilized, including for a range of applications, including consumer goods, industrial equipment, electronics, optics, medical and biotech.

For example, SAM's of the present invention find utility in repellency treatments to modify the repellency properties of a surface at the nanoscale level, including hydrophobic and oleophobic treatments, to create surfaces that are easy to clean, water resistant, oil resistant, and/or anti-smudge.

For example, SAMs of the present invention find utility in adhesion promotion, in all sorts of applications, including electronics and industrial applications.

For example, SAM's of the present invention find utility in the treatment of substrates, powders and particles, comprising a wide range of materials including metals, metal oxides, polymers and ceramics, and comprising a wide range of sizes all the way down to nanoparticles.

The SAM's of the present invention find utility in modifying all or part of the surfaces of equipment, such as but not limited to, level sensors, sucker rods, turbine meters, coriolis meters, magnetic flow meters, down hole pumps, check valves, valves, cables, drill bits, wire lines, and pigs, tuning forks, LACT units, separators, just to name a few. The present invention is useful for surfaces that come into contact with hydrocarbon liquids, including both crude oils and condensates, in which paraffins and/or asphaltenes are present or may become present and may deposit on any surface of such equipment. The present invention is useful for surfaces of equipment that may come into contact with other fluids like glycols and glycol-based compounds, drag reducing agents or other similar operating conditions where the surface of said equipment can be fouled by contaminants and/or deposits.

As a non-limiting example, the present invention may find utility when utilized with sucker rods. In the production of oil and gas, a sucker rod is a rod, typically made of steel and between 25 and 30 feet (7 to 9 meters) in length, and threaded at both ends, used to join together the surface and downhole components of a reciprocating piston pump installed in an oil well. The pump jack is the visible above-ground drive for the well pump and is connected to the downhole pump at the bottom of the well by a series of interconnected sucker rods that are extending through the cased or uncased wellbore. One problem encountered by sucker rods is the buildup of paraffin/asphaltenes on the surface of the sucker rod during operation in oil and gas wells. The buildup may occur to such an extent that the rod string can break under the added weight of the combined rod string and wax. In further method embodiments the present invention may be applied to one or more surfaces of the sucker rod to slow down, discourage or even prevent such buildup, resulting in further apparatus and products of the present invention.

The present invention will also have utility with a wide variety of flow meters in which it is important to slow down and/or prevent buildup of paraffin/wax on any surface of the meter to maintain the integrity of the meter. The present invention is believed to be useful on the surfaces of at least the following flow meters: mechanical flow meters such as piston meter/rotary piston (for example, oval gear meter), gear meter (for example helical gear nutating disk meter), variable area meter, turbine flow meter, Woltman meter, single jet meter, paddle wheel meter, multiple jet meter, Pelton wheel and current meter; pressure-based meters such as venturi meter, orifice plate, Dall tube, pitot-tube, multi-hole pressure probe, cone meters and linear resistance meters; optical flow meters; open-channel flow measurement meters such as level to flow, area/velocity, dye testing and acoustic doppler velocimetry; thermal mass flow meters such as the MAF sensor; Vortex flow meters; electromagnetic, ultrasonic and coriolis flow meters such as magnetic flow meters, non-contact electromagnetic flow meters, ultrasonic flow meters (Doppler, transit time), and coriolis flow meters; and laser Doppler flow measurement meters.

As another non-limiting example, the present invention may also have utility with turbine meters. In general, a turbine flow meter (better described as an axial turbine) translates the mechanical action of the turbine rotating in the liquid flow around an axis into a user-readable rate of flow (gpm, lpm, etc.). The turbine tends to have all the flow traveling around it. The turbine wheel is set in the path of a fluid stream. The flowing fluid impinges on the turbine blades, imparting a force to the blade surface and setting the rotor in motion. When a steady rotation speed has been reached, the speed is proportional to fluid velocity. Optionally, there may be positioned upstream and/or downstream of the turbine wheel one or more fluid stabilizers to help stabilize the fluid flow prior to contact with the turbine meter and/or as the fluid flows away from the turbine meter. Turbine meters are carefully machined to straighten the flow of fluids and pass them through a turbine to measure the flow through the meter. When operating in an oil and gas environment, especially where paraffin/asphaltene are an issue, the surfaces of the stabilizers, turbine wheel and/or even tube in which they are positioned may become coated with such paraffin/asphaltene buildup. When these surfaces become irregular due to such buildup they then cease to function properly and give erroneous results. In extreme cases deposition on the straightening vanes, turbine blades or housing may lead to plugging of the meter. Thus, in further method embodiments the present invention may be applied to one or more surfaces of the turbine meter, including to one or more surfaces of the stabilizers, turbine wheel and/or even tube in which they are positioned, to slow down, discourage or even prevent such buildup, resulting in further apparatus and products of the present invention.

Coriolis meters (also known as inertial or mass flow meters) are well known devices that measure mass flow rate of a fluid traveling through a tube. The mass flow rate is the mass of the fluid traveling past a fixed point per unit time. Coriolis meters generally comprise a set of parallel tubes in rotation or vibration, and an actuator which induces a vibration of the tubes. When the fluid to be measured is flowing, it is led through two parallel tubes that are designed to be counter-vibrating. The actual frequency of the vibration depends on the size of the mass flow meter, and commonly ranges from 80 to 1000 vibrations per second. When no fluid is flowing, the vibration of the two tubes is symmetrical. However, when there is mass flow, there is some twisting of the tubes. In those portions of the tube through which fluid flows away from the axis of rotation it must exert a force on the fluid to increase its angular momentum, so it is lagging behind the overall vibration. In other portions of the tube through which fluid is pushed back towards the axis of rotation it must exert a force on the fluid to decrease the fluid's angular momentum again, hence that arm leads the overall vibration. The inlet tube and the outlet tube vibrate with the same frequency as the overall vibration, but when there is mass flow the two vibrations are out of sync: the inlet arm is behind, the outlet arm is ahead. The two vibrations are shifted in phase with respect to each other, and the degree of phase-shift is a measure for the amount of mass that is flowing through the tubes. As might be guessed, flow of fluid though these tubes, is quite sensitive to any paraffin/asphaltene buildup which might occur, especially when the fluid is a crude oil. Specifically, paraffin and asphaltene buildup on the surfaces of measurement tubes will cause a change in the cross sectional area of the tube at the point of buildup, and will cause a change in the mass of the tube at the point of buildup, either of which will have a detrimental effect on any resulting measurement. Thus, in further method embodiments the present invention may be applied to one or more surfaces of the Coriolis meter in contact with the flowing fluid (i.e., the interior surfaces of the tubes), to slow down, discourage or even prevent such buildup, resulting in further apparatus and products of the present invention.

Magnetic flow meters, often called “mag meter”s or “electromag”s, use a magnetic field applied to the metering tube, which results in a potential difference proportional to the flow velocity perpendicular to the flux lines. The potential difference is sensed by electrodes aligned perpendicular to the flow and the applied magnetic field. The physical principle at work is Faraday's law of electromagnetic induction. The magnetic flow meter requires a conducting fluid and a nonconducting pipe liner. The electrodes must not corrode in contact with the process fluid; some magnetic flowmeters have auxiliary transducers installed to clean the electrodes in place. The applied magnetic field is pulsed, which allows the flowmeter to cancel out the effect of stray voltage in the piping system. Because the magnetic flow meters measure the electromagnetic flux across the whole diameter of the measuring tube, they can be subject to asphaltene and asphaltene deposits that reduce the diameter and interfere with the proper operation of the meter. Thus, in further method embodiments the present invention may be applied to one or more surfaces of the magnetic flow meter in contact with the flowing fluid (i.e., the electrode and/or the interior of the flow tube), to slow down, discourage or even prevent such buildup, resulting in further apparatus and products of the present invention.

Downhole pumps, both reciprocating as well as rotational both suffer from wax and asphaltene deposition. On reciprocating pumps, the ball and seat assemblies can be fouled preventing a good seal and disrupting pump operation. Rotating pumps rely on spinning stages to increase pressure and small changes in the stage shape can cause flow to be disrupted and efficiency to drop to a point the pump must be pulled and replaced. Thus, in further method embodiments the present invention may be applied to one or more surfaces of downhole pumps in contact with the pumped fluid to slow down, discourage or even prevent such buildup, resulting in further apparatus and products of the present invention.

Check valves are used to control fluid by sealing at a specified pressure and only allowing flow when the pressure on the other side of the value exceeds the sealing pressure. The sealing pressure could come from well fluids, a spring, a control line, or other source of force. Check valves are often used as safety devices to allow flow to be relieved if a critical pressure is reached or to only allow flow if pressure is applied. In either case deposition on the internal components of the valve can either cause the valve to fail to open or fail to close which could shut in production or create a potentially hazardous situation due to over pressurizing a line or vessel. Thus, in further method embodiments the present invention may be applied to one or more surfaces of check valves in contact with fluid to slow down, discourage or even prevent such buildup, resulting in further apparatus and products of the present invention.

Valves are used to control flow both for simple on and off control as well as to regulate flow rate. When the sealing surfaces are fouled with deposits, they no longer can function as designed. When valves can no longer properly control flow a variety of problems such as leaks, spills, fires, gas releases, or other hazards can occur. Thus, in further method embodiments the present invention may be applied to one or more surfaces of valves in contact with fluid to slow down, discourage or even prevent such buildup, resulting in further apparatus and products of the present invention.

Cables are used to supply power to downhole equipment. Deposits can form on the outside of the cables. Weight can become a problem with unsupported cables which could lead to breakage. For cables that are strapped to pipe the deposition interferes with the strapping used to keep the cable attached to the pipe. This slows the process of removing the equipment from the well. Thus, in further method embodiments the present invention may be applied to one or more surfaces of cables in contact with fluid to slow down, discourage or even prevent such buildup, resulting in further apparatus and products of the present invention.

Wirelines are used to clean wells, set tools, log wells, fish for broken tools or equipment and many other functions. Wirelines can pick up deposits that impede their ability to feed through guides, increase weight, foul centralizers, skates and other critical equipment needed for proper operation. Thus, in further method embodiments the present invention may be applied to one or more surfaces of wirelines in contact with fluid to slow down, discourage or even prevent such buildup, resulting in further apparatus and products of the present invention.

Non-limiting examples of commercial applicability of the present invention include petroleum production, petroleum pipelines, petroleum equipment (storage tanks and specialty vessels, etc.), and petroleum sensor and instrument manufacturing.

The SAMs of the present invention may also find utility in Electronics: Transistor devices like Organic Thin film transistors, Organic light-emitting diodes.

The SAMs of the present invention may also find utility in well treatments.

The SAMs of the present invention may also find utility in medical applications, such as but not limited to modification of biomaterials and biosensors. Further, from a biomedical point of view a wide variety of biomolecules and biomaterials involving proteins, peptides, DNA, carbohydrates, antibodies, and therapeutics, may be attached to the same of the SAMs of the present invention. Thus, the SAMs of the present invention may be utilized for implanting functional molecules on surfaces or to modify chemical-physical properties of themselves.

The SAMs of the present invention find utility with the attachment of therapeutic drugs to functional self-assembled monolayers (SAMs) after their assembly on a substrate (for example 316L SS) and can serve as a localized drug delivery system.

### EXAMPLES

The following prophetic reaction scheme and prophetic examples are provided merely as an illustration of one non-limiting embodiment of the present invention and does not in any way limit the scope of the claims.

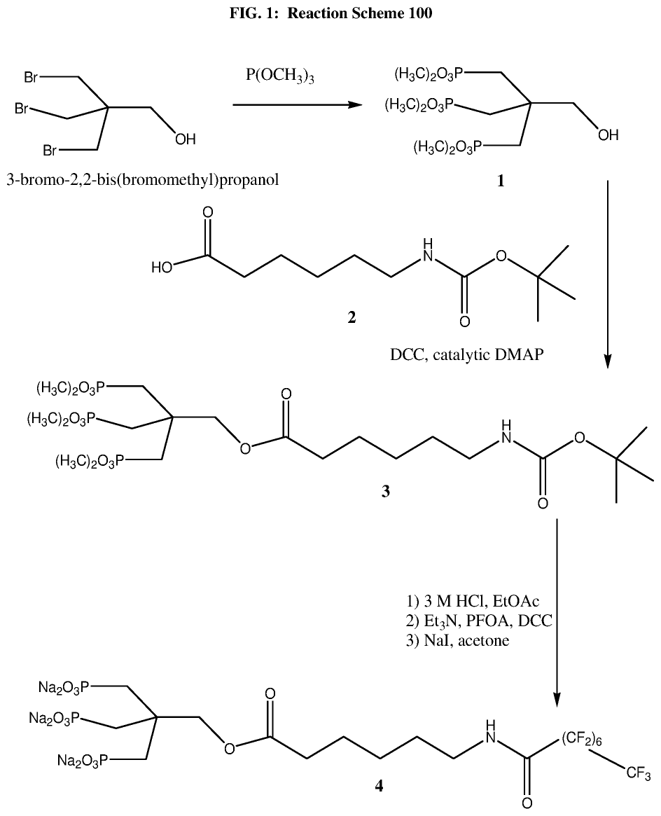

Referring now to FIG. 1, there is shown a schematic representation of Reaction Scheme 100, a non-limiting example of a reaction scheme suitable for use in the present invention:

### Example 1: Preparation of Intermediate 1

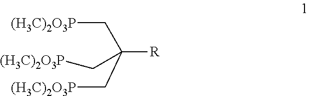

The preparation of compounds suitable for use as Intermediate 1 in this prophetic reaction scheme are well known. In this prophetic example, 3-Bromo-2,2-bis(bromomethyl)propanol (3.25 g, 0.01 mol) may be dissolved in DMF (20 mL), followed by the addition of trimethyl phosphite (4.96 g, 4.72 mL). The resulting solution is then heated at 80° C. for 12 h under inert atmosphere. The solvent is then as removed in vacuum and upon standing the desired product 1 is obtained as a light yellow solid (ca. 4.12 g, ca. 100% yield). See, Bhattacharya, A. K.; Thyagarajan, G. Chem. Rev. 1981, 81, 415-430.

### Example 2: Preparation of Intermediate 3

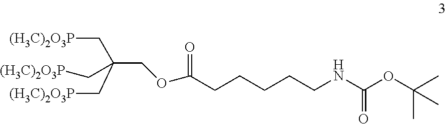

The preparation of compounds suitable for use as Intermediate 3 are well known. In general, Intermediate 1 (4.12 g, 0.01 mol) and N-Boc-6-amino-1-hexanoic acid 2 (2.53 g, 0.011 mol) are mixed with a catalytic amount of 4-(dimethylamino)pyridine (0.03 g) and dissolved in anhydrous CH₂Cl₂ (40 mL), followed by the addition of N,N′-dicyclohexylcarbodiimide (DCC, 2.27 g, 0.011 mol). See, Hassner, A.; Alexanian, V. Tetrahedron Lett. 1978, 19, 4475. The solution is stirred at rt for 12 h and subsequently filtered to removed insoluble urea by-product. The filtrate is concentrated to an oil, and then further purified with silica gel flash chromatography (SiO₂, eluent CH₂Cl₂, 3% MeOH/CH₂Cl₂). Upon standing, the desired product 3 (5.75 g, 92%) will be obtained as a white solid.

### Example 3: Preparation of Product 4

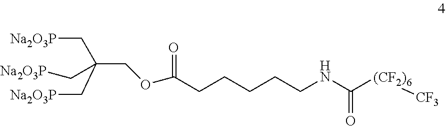

Intermediate 3 (5.75 g, 0.0092 mol) is dissolved in anhydrous CH₂Cl₂ (20 mL), followed by the addition of 3M HCl in EtOAc solution (0.0184 mol, 6.15 mL). See, Stahl, G. L.; Walter, R.; Smith, C. W. J. Org. Chem. 1978, 43, 2285. The mixture is then stirred at ambient temperature for 16 h before the solvent is removed under vacuum. The viscous residue may be re-dissolved in CH₂Cl₂ (40 mL). Triethylamine (Et₃N, 1.92 mL, 0.0138 mol), perfluorooctanoic acid (PFOA, 4.97 g, 0.012 mol) and DCC (2.12 g, 0.012 mol) are added to the solution in sequence. The mixture is then stirred under inert atmosphere for 12 h. After the insoluble urea by-product was filtered off, the clear filtrate is concentrated to afford a light-yellow oil, which was further purified with silica gel flash chromatography (SiO₂, eluent CH₂Cl₂, 3% MeOH/CH₂Cl₂). The purified oil is further dissolved in acetone (100 mL). Following addition of NaI (13.8 g, 0.092 mol), the mixture is then refluxed for 24 h under inert atmosphere. The solvent is removed under vacuum and the residue is washed thoroughly with DI water to yield 4 (ca. 9.0 g). (Delfino, J. M.; Stankovic, C. J.; Schreiber, S. L.; Richards, F. M. Tetrahedron Lett. 1987, 28, 2323.)

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the present disclosure as set forth herein. Accordingly, the scope of protection is not limited by the description set out above, but is only limited by the claims, including all equivalents of the subject matter of the claims.

The foregoing outlines several embodiments with numerous features so that those skilled in the art may better understand the aspects of the disclosure. Those skilled in the art should appreciate that they may readily use the disclosure as a basis for designing or modifying other processes and compositions for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an,” and other singular terms are intended to include the plural forms thereof unless specifically excluded.

All materials described, cited and/or referenced herein, including patents, patent publications, books, journals, articles, websites/pages, and any other publications, are incorporated by reference for all that they disclose or teach.

What is claimed is:

1. A composition comprising a head having at least 3 phosphonate groups, a functional end group, a linker having a first end and a second end, with the head appended to the first end of the linker, and the functional end group appended to the second end of the linker.

2. The composition of claim 1, wherein the head group comprises exactly 3 phosphonate groups.

3. The composition of claim 1, wherein the linker comprises a number of carbons equal to any one of the following integers, or may comprises a number of carbons in the range from/to or between any two of the following integers: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

4. The composition of claim 1, wherein the composition has the general formula of Formula I, Formula II, Formula III, or mixtures thereof, wherein:
each R₁ is independently an H, Li, Na, K, or an alkyl group having from 1 to 20 carbon atoms that is substituted or unsubstituted, linear or branched, or saturated or unsaturated;
R₂ is a single chemical bond, —O—, S—, or —NH—;
each R₃ independently comprises an alkyl group comprising up to 50 carbon atoms, in which the alkyl group is linear or branched, substituted or unsubstituted, or saturated or unsaturated;
R₄ is an alkyl group comprising up to 50 carbon atoms in which the alkyl group is linear or branched, substituted or unsubstituted, or saturated or unsaturated; and,
each X is independently a single bond, —O—, or —S—.

5. The composition of claim 1, wherein R₄ is —(CH₂)ₙ—Y₁—Z or —(CH₂)ₙ—Y₁—(CH₂)ₚ—Y₂—Z, and wherein n and p, are independently integers between 1 and 50 and may be the same or different, and wherein Y₁ and Y₂ are independently —O—, —S—, —NH—, —OCO—, —SCO—, —HNCO—, or —HNCO—CF(CF₃)—, and wherein Z is H, R_{f}, —(OCF₂CF₂)ₙ—OR_{f}, —(OCF₂CF(CF₃))ₙ—OR_{f}, or —(OCF(CF₃)CF₂)ₙ—OR_{f}, wherein R_{f} comprises a perfluorinated alkyl having from 1 to 50 carbon atoms, that is linear or branched, saturated or unsaturated, or substituted or unsubstituted.

6. A product comprising a surface, wherein at least a portion of the surface comprises a composition comprising a head having at least 3 phosphonate groups, a functional end group, a linker having a first end and a second end, with the head positioned at the first end of the linker, and the functional end group appended to the second end of the linker.

7. The product of claim 6, wherein the head group comprises exactly 3 phosphonate groups.

8. The product of claim 6, wherein the linker comprises a number of carbons equal to any one of the following integers, or may comprises a number of carbons in the range from/to or between any two of the following integers: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

9. The product of claim 6, wherein the composition has the general formula of Formula I, Formula II, Formula III, or mixtures thereof, wherein:
each R₁ is independently H, Li, Na, K, or an alkyl group having from 1 to 20 carbon atoms, that is substituted or unsubstituted, linear or branched, or saturated or unsaturated;
R₂ is a single chemical bond, O—, —S—, or —NH—;
each R₃ independently comprises an alkyl group comprising up to 50 carbon atoms, in which the alkyl group is linear or branched, substituted or unsubstituted, or saturated or unsaturated;
R₄ is an alkyl group comprising up to 50 carbon atoms which the alkyl group is linear or branched, substituted or unsubstituted, or saturated or unsaturated; and,
each X is independently a single bond, —O—, or —S—.

10. The product of claim 6, wherein R₄ is —(CH₂)ₙ—Y₁—Z, or —(CH₂)ₙ—Y₁—(CH₂)ₚ—Y₂—Z, and wherein n and p, are independently integers between 1 and 50 and may be the same or different, and wherein Y₁ and Y₂ are independently a single chemical bond, —O—, S—, —NH—, —OCO—, —SCO—, —HNCO—, or —HNCO—CF(CF₃)—, and wherein Z is H, R_{f}, —(OCF₂CF₂)ₙ—OR_{f}, —(OCF₂CF(CF₃))ₙ—OR_{f}, or —(OCF(CF₃)CF₂)ₙ—OR_{f}, wherein R_{f} comprises a perfluorinated alkyl having from 1 to 50 carbon atoms, that is linear or branched, saturated or unsaturated, or substituted or unsubstituted.

11. A machine comprising a surface, wherein at least a portion of the surface comprises a composition comprising a head having at least 3 phosphonate groups, a functional end group, a linker having a first end and a second end, with the head positioned at the first end of the linker, and the functional end group appended to the second end of the linker.

12. The machine of claim 12, wherein the head group comprises exactly 3 phosphonate groups.

13. The machine of claim 12, wherein the linker comprises a number of carbons equal to any one of the following integers, or may comprises a number of carbons in the range from/to or between any two of the following integers: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

14. The machine of claim 12, wherein the composition has the general formula of Formula I, Formula II, Formula III, or mixtures thereof, wherein:
each R₁ is independently H, Li, Na, K, an alkyl group having from 1 to 20 carbon atoms, that is substituted or unsubstituted, linear or branched, or saturated or unsaturated;
R₂ is a single chemical bond, —O—, —S—, or —NH—;
each R₃ independently comprises an alkyl group comprising up to 50 carbon atoms, in which the alkyl group is linear or branched, substituted or unsubstituted, saturated or unsaturated;
R₄ is an alkyl group comprising up to 50 carbon atoms in which the alkyl group is linear or branched, substituted or unsubstituted, or saturated or unsaturated; and,
each X is independently selected from a group consisting of a single bond, or —O—, or —S—.

15. The machine of claim 12, wherein R₄ is —(CH₂)ₙ—Y₁—Z or —(CH₂)ₙ—Y₁—(CH₂)ₚ—Y₂—Z, and wherein n and p, are independently integers between 1 and 50 and may be the same or different, and wherein Y₁ and Y₂ are a single chemical bond, —O—, —S—, —NH—, —OCO—, —SCO—, —HNCO—, or —HNCO—CF(CF₃)—, and wherein Z is H, R_{f}, —(OCF₂CF₂)ₙ—OR_{f}, —(OCF₂CF(CF₃))ₙ—OR_{f}, or —(OCF(CF₃)CF₂)ₙ—OR_{f}, wherein R_{f} comprises a perfluorinated alkyl having from 1 to 50 carbon atoms, that is linear or branched, saturated or unsaturated, and substituted or unsubstituted.

16. A method of treating a surface, comprising contacting the surface with a treating composition comprising a head having at least 3 phosphonate groups, a functional end group, a linker having a first end and a second end, with the head positioned at the first end of the linker, and the functional end group appended to the second end of the linker.

17. The method of claim 16, wherein the head group comprises 3 phosphonate groups.

18. The method of claim 16, wherein the linker comprises a number of carbons equal to any one of the following integers, or may comprises a number of carbons in the range from/to or between any two of the following integers: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

19. The method of claim 16, wherein the composition has the general formula of Formula I, Formula II, Formula III, or mixtures thereof, wherein:
each R₁ is independently H, Li, Na, K, or an alkyl group having from 1 to 20 carbon atoms that is substituted or unsubstituted, linear or branched, or saturated or unsaturated;
R₂ is a single chemical bond, —O—, —S—, —NH—;
each R₃ independently comprises an alkyl group comprising up to 50 carbon atoms, in which the alkyl group is linear or branched, substituted or unsubstituted, or saturated or unsaturated;
R₄ is an alkyl group comprising up to 50 carbon atoms in which the alkyl group is linear or branched, substituted or unsubstituted, or saturated or unsaturated; and,
each X is independently selected from a group consisting of a single bond, —O—, or —S—.

20. The method of claim 17, wherein R₄ is —(CH₂)ₙ—Y₁—Z or —(CH₂)ₙ—Y₁—(CH₂)ₚ—Y₂—Z, and wherein n and p, are independently integers between 1 and 50 and may be the same or different, and wherein Y₁ and Y₂ are independently selected from the group consisting of a single chemical bond, —O—, —S—, —NH—, —OCO—, —SCO—, —HNCO—, or —HNCO—CF(CF₃)—, and wherein Z is H, R_{f}, —(OCF₂CF₂)ₙ—OR_{f}, —(OCF₂CF(CF₃))ₙ—OR_{f}, or —(OCF(CF₃)CF₂)ₙ—OR_{f}, wherein R_{f} comprises a perfluorinated alkyl having from 1 to 50 carbon atoms, that is linear or branched, saturated or unsaturated, or substituted or unsubstituted.
